(19) United States
(12) Patent Application Publication
(10) Pub. No.: US 2009/0225461 A1
(43) Pub. Date: Sep. 10, 2009

(54) DATA STORAGE DEVICE

(75) Inventor: Jun Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/393,773

(22) Filed: Feb. 26, 2009

(30) Foreign Application Priority Data
Mar. 7, 2008 (JP) 2008-057688

(51) Int. Cl. G11B 27/36; G11B 5/00

(52) U.S. Cl. 360/31; 360/76; G9B/5; G9B/27.052

(57) ABSTRACT

A device for storing data includes: a medium for storing data, the medium having a plurality of areas in a circumferential direction; a head including a read element for reading data from the medium along the circumferential direction, a write element for writing data into the medium along the circumferential direction, and a heater for controlling a distance between the head and the medium; a memory for storing information of a parameter of the heater for controlling the distance between the head and the medium; and a controller for controlling the heater to control the distance between the head and the medium separately among the areas when reading data from or writing data into any one of the areas of the medium.

### CROSS-REFERENCE TO RELATED APPLICATION

This application is based upon and claims the benefit of priority of the prior Japanese Patent Application No. 2008-057688, filed on Mar. 7, 2008, the entire contents of which are incorporated herein by reference.

### FIELD

The embodiment discussed herein is related to a data storage device.

### BACKGROUND

It is important to reduce the fly height of a head from a recording surface of a magnetic disk so as to achieve a high recording density of a magnetic disk device. Thus, recently, a fly height of the order of 10 nm has been achieved.

However, when the fly height of a head is reduced, the head is likely to collide with micro-protrusions on a magnetic disk surface. Moreover, variations in clearance for each head exist within the tolerance limits of a mechanism. Thus, in view of contact with a medium described above, small fly height such that the tolerance limits are exceeded cannot be set.

Recently, a magnetic storage device controls the fly height of a magnetic head by changing the amount of protrusion of the magnetic head by heating using a heating element provided in the magnetic head and a magnetic storage device.

Accordingly, for example, International Publication Pamphlet No. WO 2002/037480, Japanese Laid-open Patent Publication No. 2005-71546, Japanese Laid-open Patent Publication No. 2005-276284, and Japanese Laid-open Patent Publication No. 2007-310978 have disclosed methods each for, using a phenomenon in which a flying head surface protrudes toward a magnetic disk due to thermal expansion (thermal protrusion (TPR)), controlling the clearance between the head and a recording surface of the magnetic disk by providing a heater in the head and applying power to the heater.

In the known arts, the dependence of head flying characteristics on the position in the radial direction exists, in which the amount of change in the fly height of a head varies in the radial direction of a magnetic disk due to, for example, wind pressure. Thus, for each head, at several positions on a magnetic disk in the radial direction, respective heater powers are measured, optimum fly height such that the head does not collide with the magnetic disk being obtained with the heater powers, and stored as data so as to optimally control the fly height of the head in the radial direction.

In the known arts, since control is performed so as to achieve optimum fly height only in the radial direction, a head does not necessarily maintain optimum fly height in the circumferential direction of a magnetic disk. Since the rotation of a magnetic disk causes a head to fly to read and write data in tracks of the magnetic disk in the circumferential direction, maintaining optimum fly height at individual areas of the magnetic disk in the circumferential direction is effective at improving read and write characteristics.

However, due to undulations on a magnetic disk in the circumferential direction and the influence of the flying follow-up characteristics of a head, in the known arts, it is difficult to, only by controlling the fly height of the head in the radial direction, control the head so as to achieve optimum fly height at individual areas of the magnetic disk in the circumferential direction.

Thus, even when the fly height of a head is controlled in the radial direction to achieve the smallest fly height such that the head does not collide with a medium, the fly height of the head changes in the circumferential direction, so that it is difficult to improve read and write characteristics.

### SUMMARY

According to an aspect of the invention, A device for storing data includes: a medium for storing data, the medium having a plurality of areas in a circumferential direction; a head including a read element for reading data from the medium along the circumferential direction, a write element for writing data into the medium along the circumferential direction, and a heater for controlling a distance between the head and the medium; a memory for storing information of a parameter of the heater for controlling the distance between the head and the medium; and a controller for controlling the heater to control the distance between the head and the medium separately among the areas when reading data from or writing data into any one of the areas of the medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is an external view of a magnetic storage device according to an embodiment of the present invention.

FIG. 2 is a block diagram of the magnetic storage device illustrated in FIG. 1.

FIG. 3 illustrates a magnetic head and a magnetic disk illustrated in FIGS. 1 and 2.

FIG. 4 is a block diagram of the magnetic head illustrated in FIGS. 1 and 2.

FIG. 5 illustrates the division of the magnetic disk illustrated in FIGS. 1 and 2 into areas.

FIG. 6 illustrates undulations on the magnetic disk illustrated in FIGS. 1 and 2 in the circumferential direction and fly height.

FIG. 7A and FIG. 7B illustrate the amount of protrusion of the magnetic head illustrated in FIG. 3.

FIG. 8A and FIG. 8B illustrate the control of the fly height of the magnetic head illustrated in FIG. 3.

FIG. 9 illustrates the division of a magnetic disk into areas according to an embodiment of the present invention.

FIG. 10 illustrates each servo frame illustrated in FIG. 9.

FIG. 11 illustrates contact determination according to an embodiment of the present invention.

FIG. 12 illustrates the results of contact determination in individual areas in FIG. 11.

FIG. 13 illustrates the results of measurement of fly height according to an embodiment of the present invention.

FIG. 14 illustrates heater powers for achieving optimum fly height obtained from the results of measurement in FIG. 13.

FIG. 15 is a flowchart illustrating the process of the measurement of fly height according to an embodiment of the present invention.

FIG. 16 illustrates a fly height control table created by the process illustrated in FIG. 15.

FIG. 17 is a flowchart illustrating the process of read and write operations according to an embodiment of the present invention.

FIG. 18 illustrates contact determination according to another embodiment of the present invention.

FIG. 19 illustrates the results of contact determination in individual areas in FIG. 18.

### DESCRIPTION OF EMBODIMENTS

Embodiments of the present invention will be described with reference to accompanying drawing. The embodiments will be described in the following order: the configuration of a magnetic storage device, the control of fly height, the measurement of fly height, read and write operations in which fly height control is performed, another method for measuring fly height, and another embodiment.

### Magnetic Storage Device

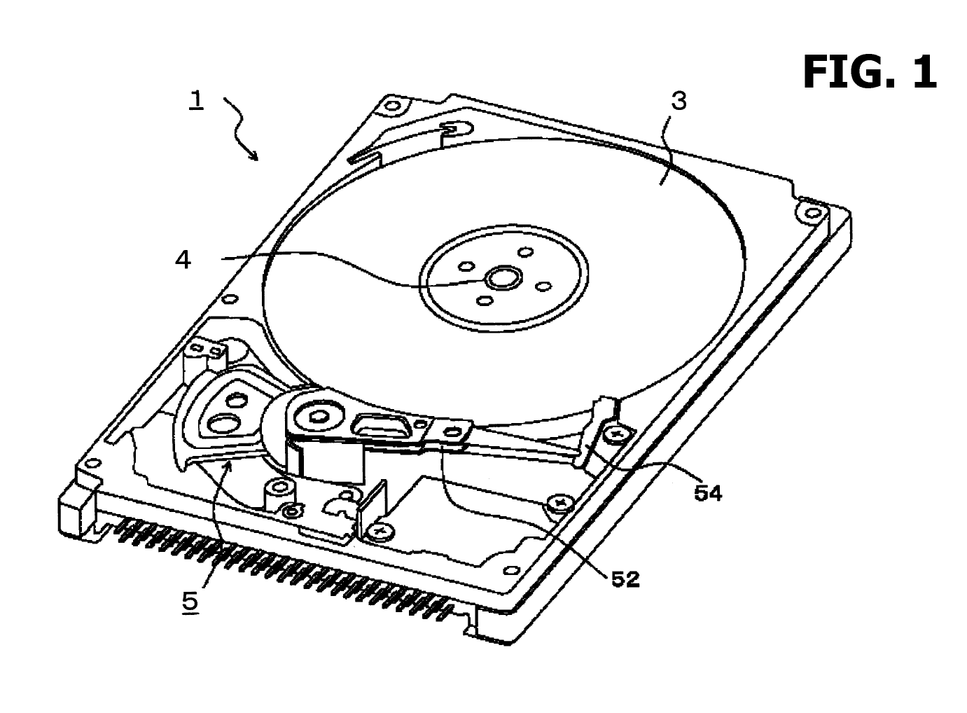

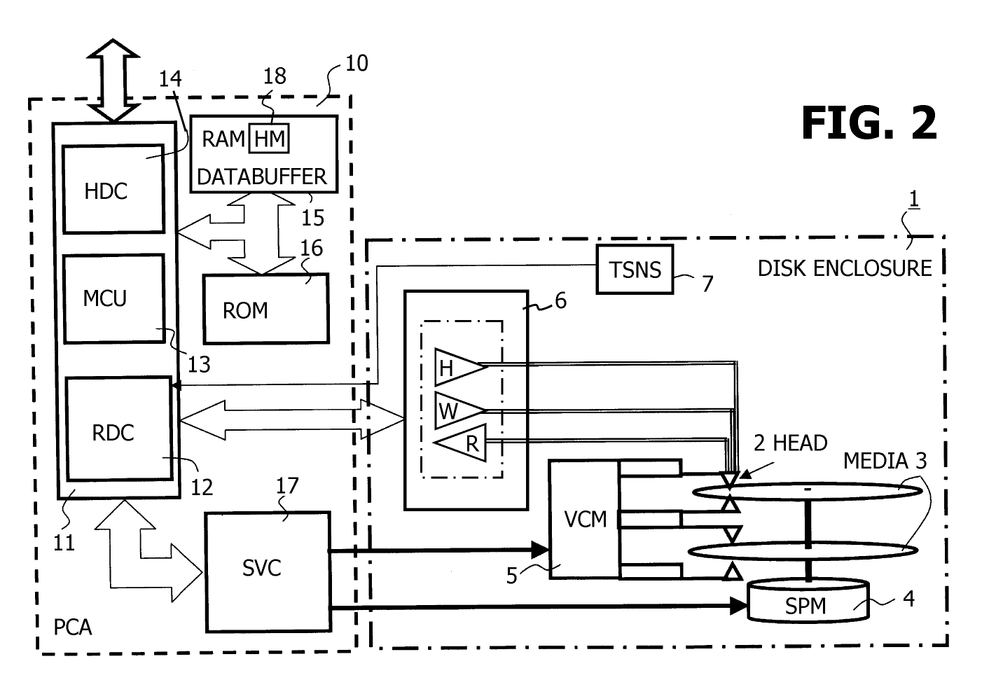

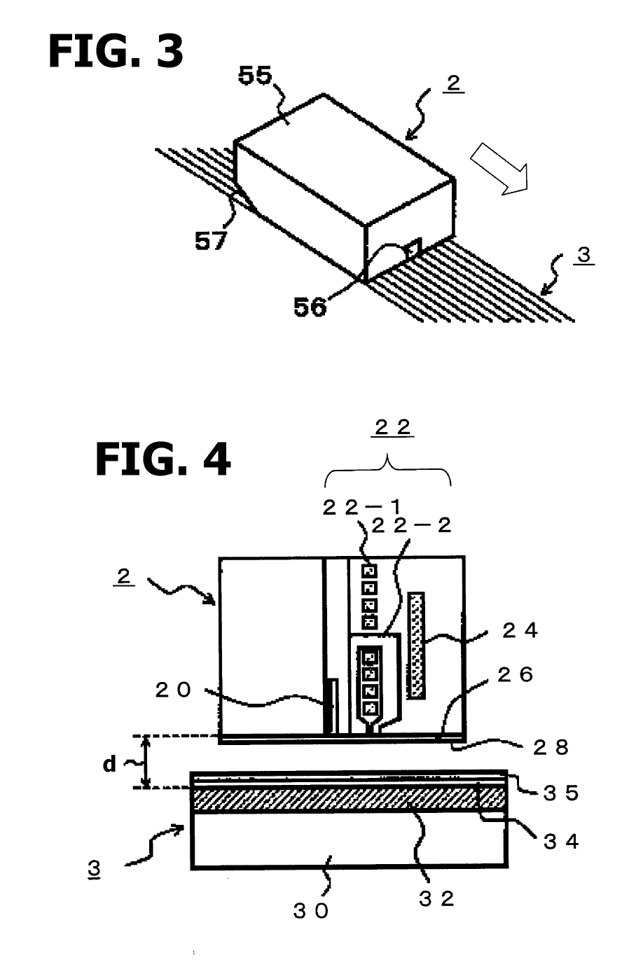

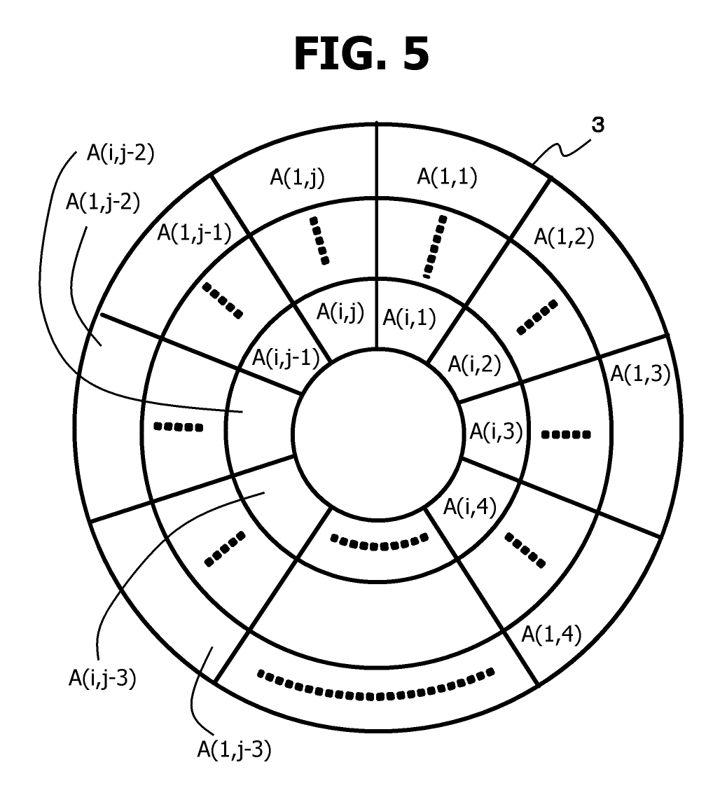

FIG. 1 is an external view of a magnetic storage device according to an embodiment of the present invention. FIG. 2 is a block diagram of the magnetic storage device illustrated in FIG. 1. FIG. 3 illustrates a magnetic head and a magnetic disk illustrated in FIGS. 1 and 2. FIG. 4 is a detailed block diagram of the magnetic head illustrated in FIGS. 1, 2, and 3. FIGS. 1 and 2 illustrate a magnetic disk device as an example of the magnetic storage device.

The magnetic disk device includes a drive unit (a disk enclosure) 1 and a printed circuit assembly (PCA) 10, as illustrated in FIG. 2. In the disk enclosure (referred to as a DE) 1, magnetic disks 3 that are magnetic recording media are provided around the rotation axis of a spindle motor 4, as illustrated in FIGS. 1 and 2. The spindle motor 4 rotates the magnetic disks 3. An actuator (referred to as a VCM) 5 includes an arm (referred to as a head actuator) 52 and magnetic heads 2 each at the top of a suspension and moves the magnetic heads 2 in the radial direction of the magnetic disks 3.

The actuator 5 includes a voice coil motor (VCM) that rotates about the rotation axis. In FIG. 2, in the magnetic disk device, the two magnetic disks 3 are provided, and the four magnetic heads 2 are driven at the same time by the same VCM 5.

Each of the magnetic heads 2 includes read and write elements, as described below. Each of the magnetic heads 2 is formed by laminating a read element that includes a magnetoresistive (MR) element on a slider and then laminating a write element that includes a write coil on the read element.

A ramp 54 for evacuating the magnetic heads 2 from the magnetic disks 3 and parking the magnetic heads 2 is provided outside the magnetic disks 3, as illustrated in FIG. 1.

A preamplifier (a head integrated circuit (IC)) 6 described in FIG. 2 is provided at a side surface of the VCM 5 in the DE 1. Moreover, the DE 1 includes a temperature sensor (not illustrated) that detects temperature in the DE 1.

On the other hand, the printed circuit assembly (a control circuit unit) 10 includes a hard disk controller (HDC) 14, a microcontroller (MCU) 13, a read-write channel circuit (RDC) 12, a servo control circuit (SVC) 17, a data buffer (a random access memory (RAM)) 15, and a read only memory (ROM) 16. In this embodiment, the HDC 14, the MCU 13, and the RDC 12 are provided in a single large-scale integration (LSI) 11.

The RDC 12 is connected to the preamplifier 6 and controls reading and writing of data in the magnetic disks 3, i.e., the RDC 12 performs data modulation and data demodulation. The SVC 17 controls the driving of the spindle motor 4 and the driving of the VCM 5.

The HDC 14 mainly performs interface protocol control, data buffer control, and disk formatting control. The RAM 15 temporarily stores, for example, read data and write data.

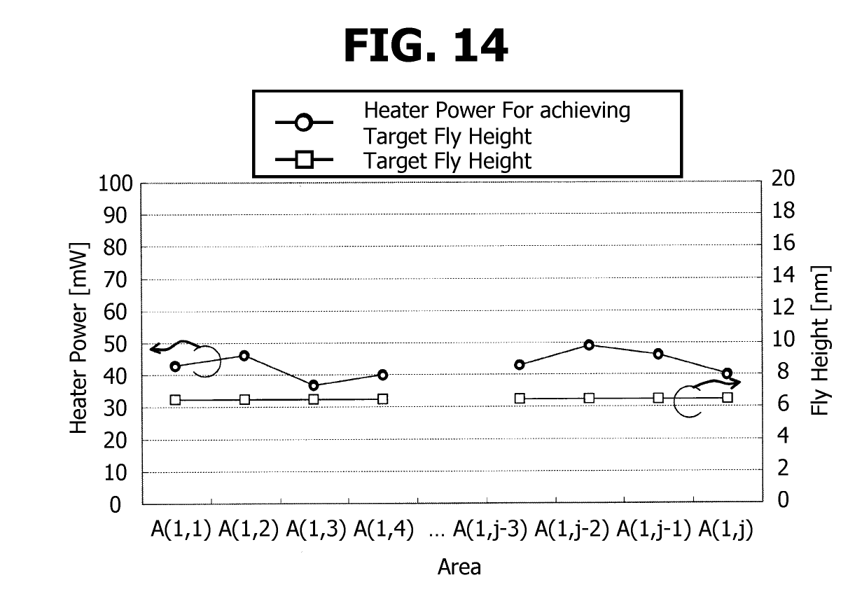

Moreover, the RAM 15 further stores a fly height control table 18 described below in FIG. 14. The fly height control table 18 is stored in a system area in the magnetic disks 3, and when the device is activated, the fly height control table 18 is read from the system area in the magnetic disks 3 and stored in the RAM 15. The fly height indicates a distance between the head and the medium. The MCU 13 may control the heater to control the fly height separately among the areas according to the fly height control table 18 when reading data from or writing data into any one of the areas of the medium.

The MCU 13 (controller) controls the HDC 14, the RDC 12, and the SVC 17 and manages the RAM 15 and the ROM 16. The ROM 16 stores, for example, various types of programs and parameters.

Each of the magnetic heads 2 includes a tapered surface 57 at the top of a slider 55 thereof and a head element 56 at the back end of the slider 55, as illustrated in FIG. 3. The movement (rotation) of the magnetic disks 3 in a direction indicated by an arrow causes the magnetic heads 2 to fly.

FIG. 4 illustrates a cross section of each of the magnetic heads 2 (the head element 56). A write element 22 is formed by winding a recording coil 22-1 around a recording core 22-2. A magnetic field corresponding to current applied to the recording coil 22-1 occurs in a write gap to perform a write operation on a corresponding one of the magnetic disks 3.

A read element (a magnetoresistive element) 20 is provided in parallel with the recording core 22-2. Moreover, a heater (a heating element) 24 is provided on a side of the recording coil 22-1. The calorific value of the heater 24 is controlled by applied heater current, and thermal expansion corresponding to the calorific value occurs. The bottom of the magnetic head 2 constitutes an air bearing surface (ABS) 26. A protective layer 28 is provided on the ABS 26.

In the magnetic disk 3, a magnetic recording film 32 is provided on a substrate 30. A protective film 34 is provided on the magnetic recording film 32. Lubricant 35 is applied to the protective film 34.

The recording coil 22-1 and the recording core 22-2 are provided in an element unit composed of, for example, ceramic material in the magnetic head 2 as the write element 22, in this manner. The read element 20 is provided adjacent to the left side of the write element 22. For example, a giant magneto resistance (GMR) element or a tunneling magneto resistance (TMR) element is used as the read element 20. The ABS 26 in the magnetic head 2 opposes the magnetic disk 3.

In the present embodiment, the heater 24 is provided in the neighborhood of the recording core 22-2, which constitutes the write element 22 in the magnetic head 2. Heating by applying power to the heater 24 causes the ABS 26, which is a flying surface of the magnetic head 2, to expand and protrude toward the magnetic disk 3. The distance between the bottom of the read element 20 and the magnetic recording film 32 in the magnetic disk 3 is defined as fly height d between the magnetic head 2 and the magnetic disk 3.

Moreover, the preamplifier 6 in FIG. 2 includes a read amplifier 64 that amplifies read signals from the read element 20 and outputs the read signals to the RDC 12, a write amplifier 63 that amplifies write signals from the RDC 12 and supplies the write signals to the write element 22, a heater drive circuit 61 that receives a set amount of power from the RDC 12 and drives the heater 24 in the magnetic head 2, and a heater control circuit (not illustrated) that controls the heater drive circuit 61.

### Fly Height Control

FIG. 5 illustrates areas of the magnetic disk 3. The magnetic disk 3 is divided into areas in the radial and circumferential directions. The most outer circumferential zone includes areas A(1, 1) to A(1, j). The most inner circumferential zone includes areas A(i, 1) to A(i, j).

The fly height of the magnetic head 2 is not constant across all the areas of the medium 3. The fly height changes in the radial direction due to the dependence of head flying characteristics on, for example, the track position and the circumferential position on a medium in the radial direction. Moreover, the fly height changes in the circumferential direction due to, for example, undulations on a medium and the flying follow-up characteristics of a head.

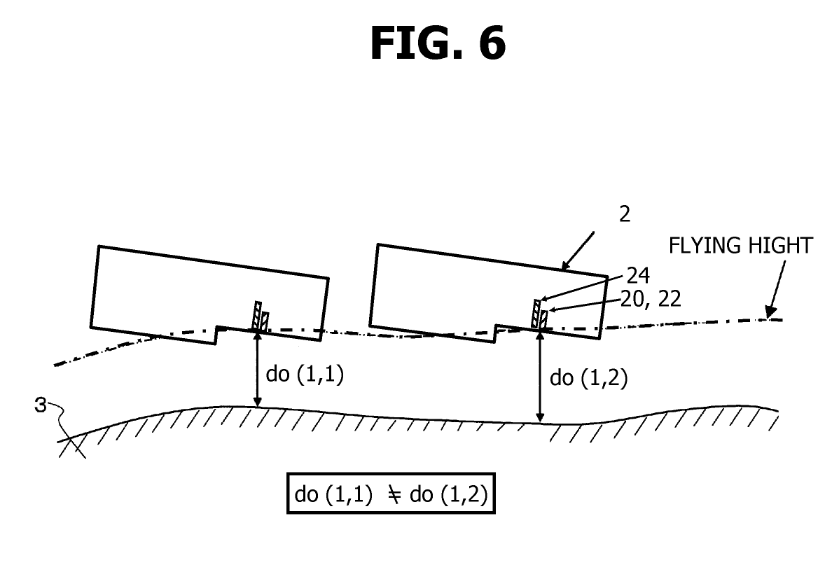

FIG. 6 illustrates how the magnetic head 2 follows the track of the magnetic disk 3. When undulations exist on the magnetic disk 3, as illustrated in the drawing, the fly height of the magnetic head 2 varies with the position on the magnetic disk 3 in the circumferential direction. For example, assuming that the fly height is 10 nm, when undulations of the order of nanometers exist on the magnetic disk 3, the fly height varies with the position from do(1, 1) to do(1, 2). Although a surface of the magnetic disk 3 is polished so as to be a flat and smooth surface, such undulations of the order of nanometers are inevitable. That is, the surface roughness of the magnetic disk 3 depends on, for example, a texture technique or a polishing technique (medium polishing).

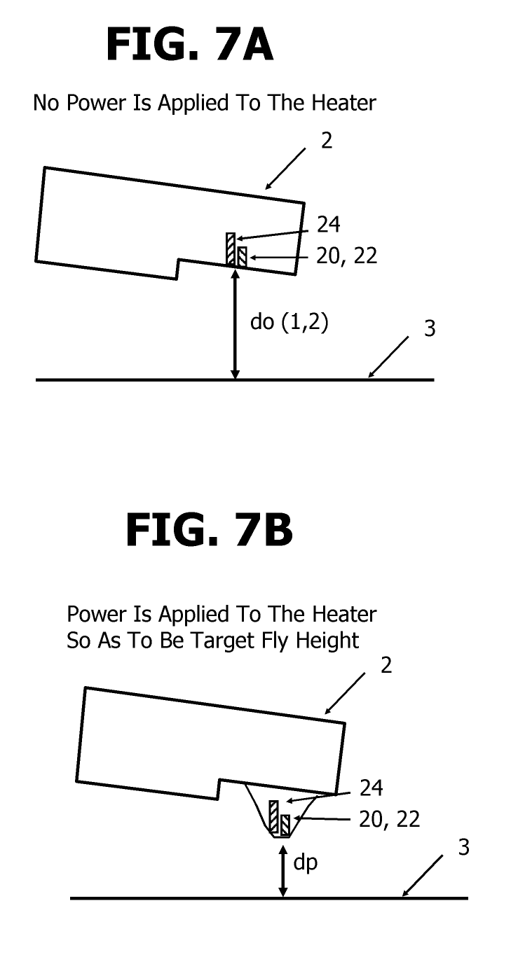

Assuming that the fly height of the magnetic head 2 described in FIG. 4 in a state in which no power is applied to the heater 24 in the magnetic head 2 is do(1, 2), when power is applied to the heater 24, the fly height reaches dp, as illustrated in FIG. 7A and FIG. 7B.

That is, when power is applied to the heater 24, thermal expansion occurs in the magnetic head 2. Since the thermal expansion occurs at the bottom of the magnetic head 2, i.e., the thermal expansion occurs in a direction toward an opposing surface of the magnetic disk medium 3 (the downward direction in FIG. 7A and FIG. 7B), as illustrated in FIG. 7A and FIG. 7B, the magnetic head 2 protrudes toward the magnetic disk medium 3. Thus, heater power is adjusted to control the fly height dp so as to be target fly height.

In order to prevent the variation of fly height in the radial and circumferential directions described above, the medium 3 is divided into a predetermined number of areas, as illustrated in FIG. 5, fly height is measured in each of the areas, and measured values are stored. Then, fly height is controlled for each of the areas in response to corresponding measured fly height. In this arrangement, fly height can be controlled so as to be constant across all the areas of the medium 3.

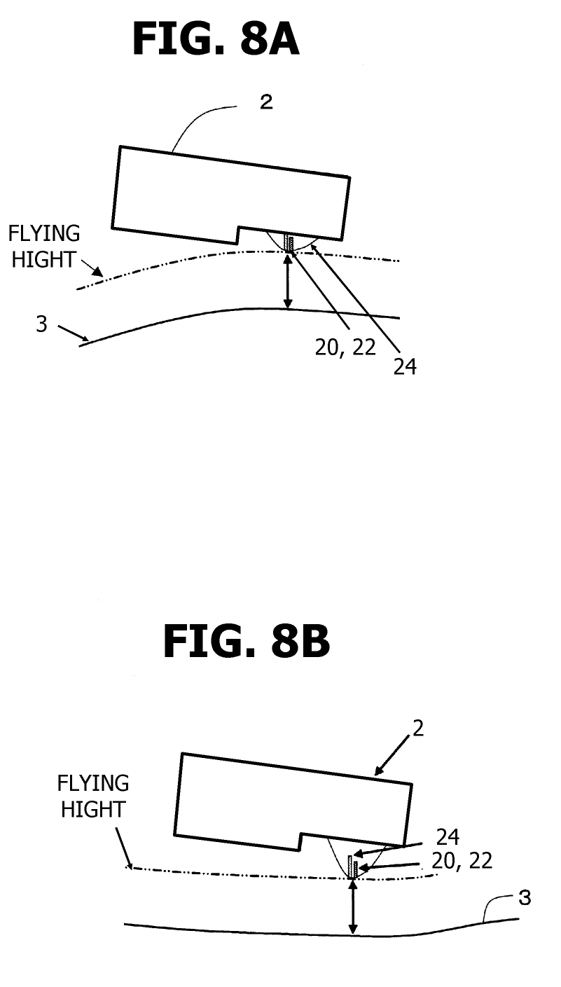

The clearance can be corrected so as to be constant in response to the variation of fly height illustrated n FIG. 7A and FIG. 7B by changing heater power to be applied to the heater 24 corresponding to target fly height for each area, as illustrated in FIG. 8A and FIG. 8B. That is, for the entire surface of the medium 3, while the smallest fly height with which reliability about contact between the magnetic head 2 and the medium 3 can be achieved is ensured, control can be performed so as to achieve small fly height advantageous for read and write characteristics. Thus, the reliability and characteristics of the magnetic disk device can be improved.

### Measurement of Fly Height

Since fly height varies with each magnetic head and the position of each magnetic head in the radial and circumferential directions, heater power for achieving constant fly height varies with each magnetic head and the position of each magnetic head. Thus, heater power for achieving constant fly height is measured for each magnetic head at each position, and the fly height control table 18 is created.

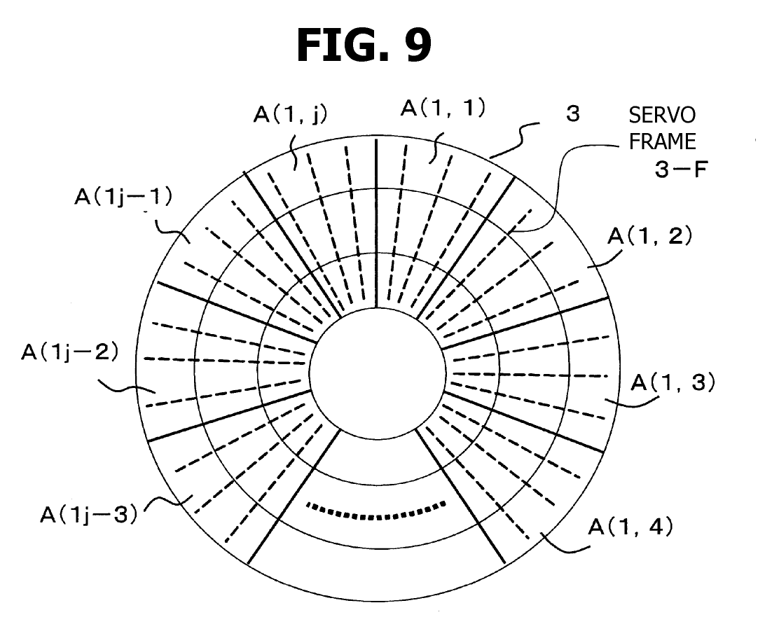

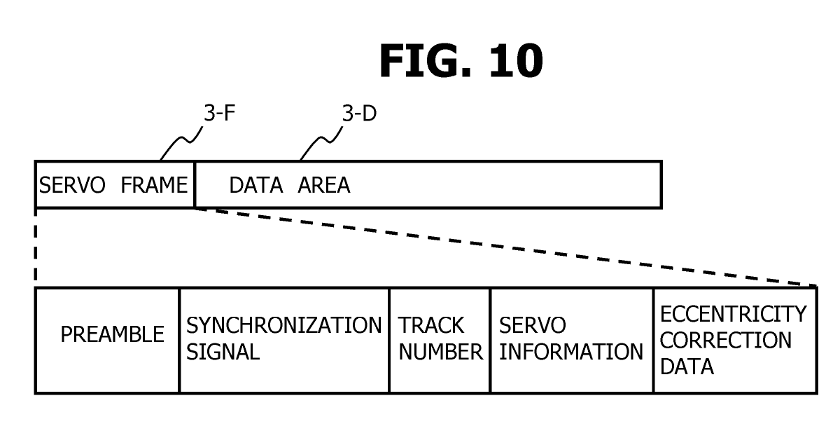

The outline of the measurement of fly height will now be described. FIG. 9 illustrates the division of the medium 3 into areas for the measurement and control of fly height. FIG. 10 illustrates the layout of each sector illustrated in FIG. 9.

In FIG. 9, the medium 3 is divided into j areas A(1, 1) to A(1, j) in the circumferential direction. Moreover, the medium 3 is divided into i areas (in this case, three areas) in the radial direction. In each of the divided areas, fly height is measured. In this case, fly height need not be measured at all positions on each of the divided areas but just needs to be measured at some points.

A servo frame 3-F is written to each sector of the magnetic disk 3, as illustrated in FIG. 9. The servo frame 3-F is provided at the top of a data area 3-D and includes a preamble, a synchronization signal, a track number, servo information, and eccentricity correction data (a postcode).

Signal amplitude can be measured by reading the preamble. In the measurement of fly height, when signal amplitude is measured in the preamble in the servo frame 3-F, for each of the divided areas, in preambles for predetermined q tracks, every time heater power is increased, the signal amplitude of predetermined p (in the drawing, three) servo frames 3-F in the area is measured, as illustrated in FIG. 9.

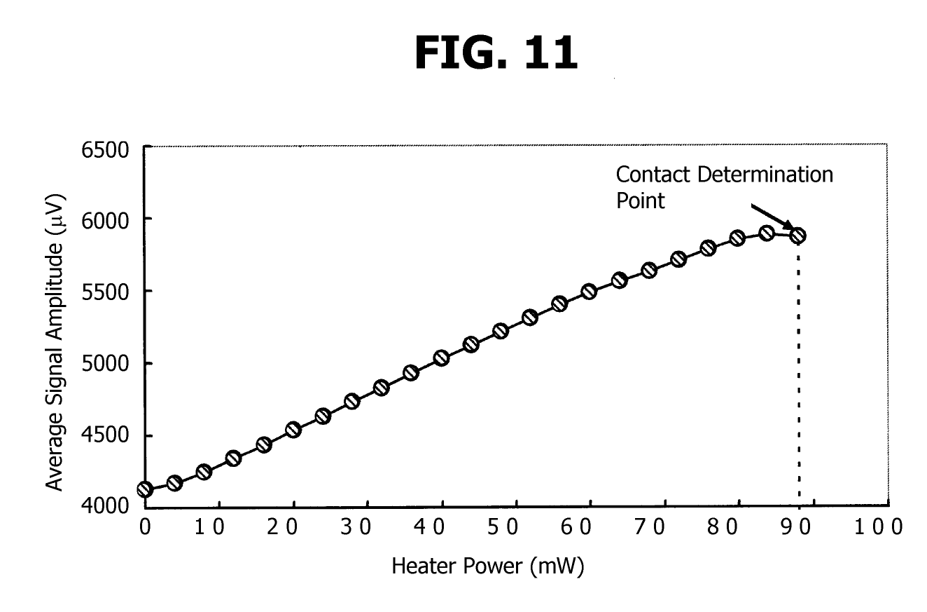

Fly height is measured in the following manner. As heater power is increased, the read element 20 and the write element 22 approach the magnetic recording film 32, so that signal amplitude increases, as illustrated in FIG. 11. In FIG. 11, the horizontal axis represents heater power (mW), and the vertical axis represents average signal amplitude (μV). However, when the magnetic head 2 comes into contact with the medium 3 (a contact determination point), signal amplitude decreases. It is determined upon detecting a decrease in signal amplitude that the magnetic head 2 has come into contact with the medium 3, and heater power applied at this time is determined as being heater power corresponding to the current fly height. Then, the average of heater powers measured in an area of interest is calculated.

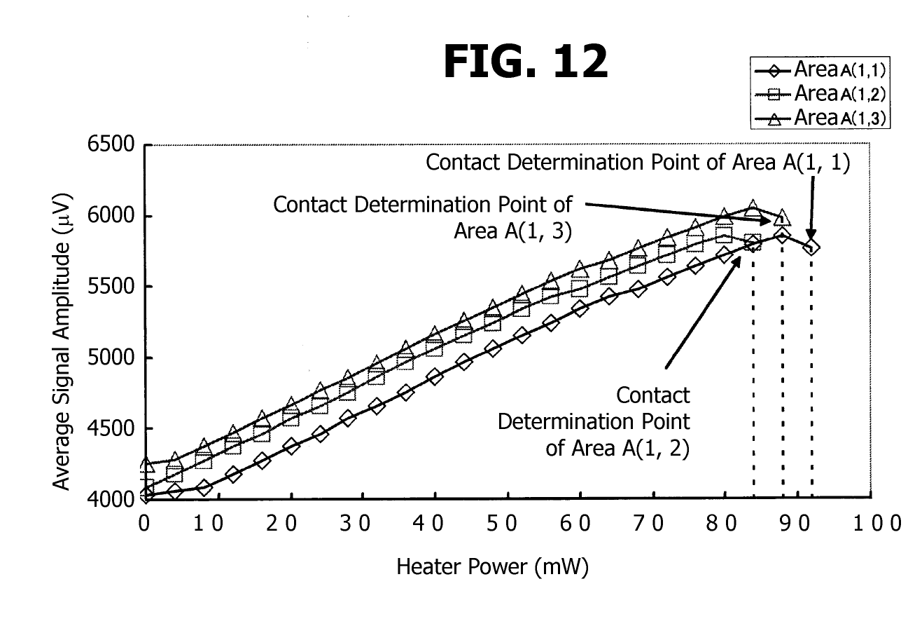

FIG. 12 illustrates points where contact is determined by heater power and signal amplitude in three areas A(1, 1), A(1, 2), and A(1, 3).

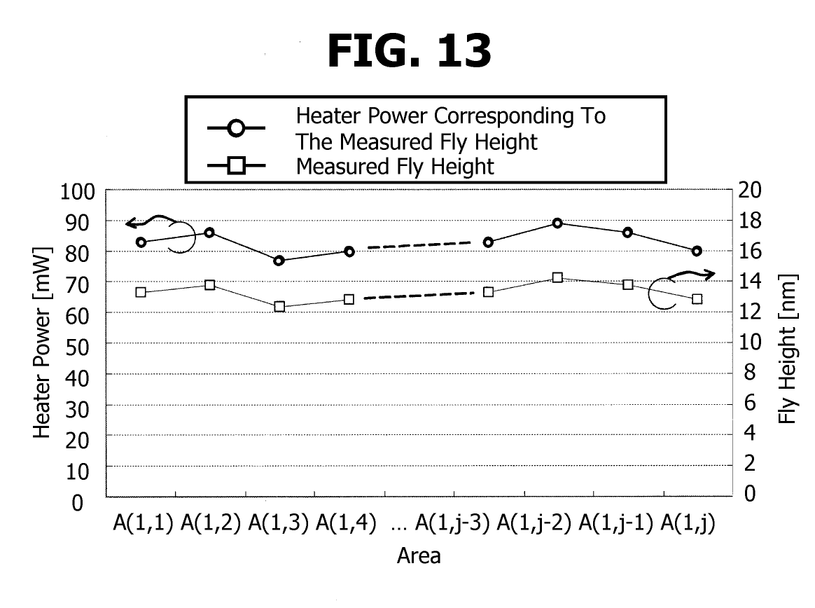

FIG. 13 illustrates measured fly height and heater power corresponding to the measured fly height in each of the divided areas. In FIG. 13, the horizontal axis represents the areas in the circumferential direction in FIG. 9, and the vertical axis represents heater powers. A white circle indicates measured fly height dA. A corresponding black circle indicates heater power hWA corresponding to the measured fly height dA.

Heater power hw corresponding to target fly height d0 is obtained by the following equation:

hw=hWA−(dA−d0)×α, (1)

where α is a conversion factor.

FIG. 14 illustrates the variation of the heater power hw obtained by equation (1) for achieving the target fly height d0. The horizontal axis represents the areas in the circumferential direction in FIG. 9, and the vertical axis represents heater powers. A white circle indicates the target fly height d0. A corresponding black circle indicates the heater power hw for achieving the target fly height d0.

Heater power in each area in the circumferential direction for achieving constant target fly height can be measured in the circumferential direction in this manner.

This enables operations with stable flying characteristics. That is, even when the fly height of each head is small and when the fly height varies with the head, a head crash caused by the contact of a head with a magnetic disk medium can be prevented, and deterioration in head output characteristics caused by the adhesion of lubricant of a magnetic disk to a head can be prevented.

Moreover, even when the variation of the fly height of each head is relatively large, a decrease in write capability caused by the extension of the propagation distance of a magnetic field generated in a write head and deterioration in the read error rate due to a decrease in the signal-to-noise (S/N) ratio of read signals can be prevented.

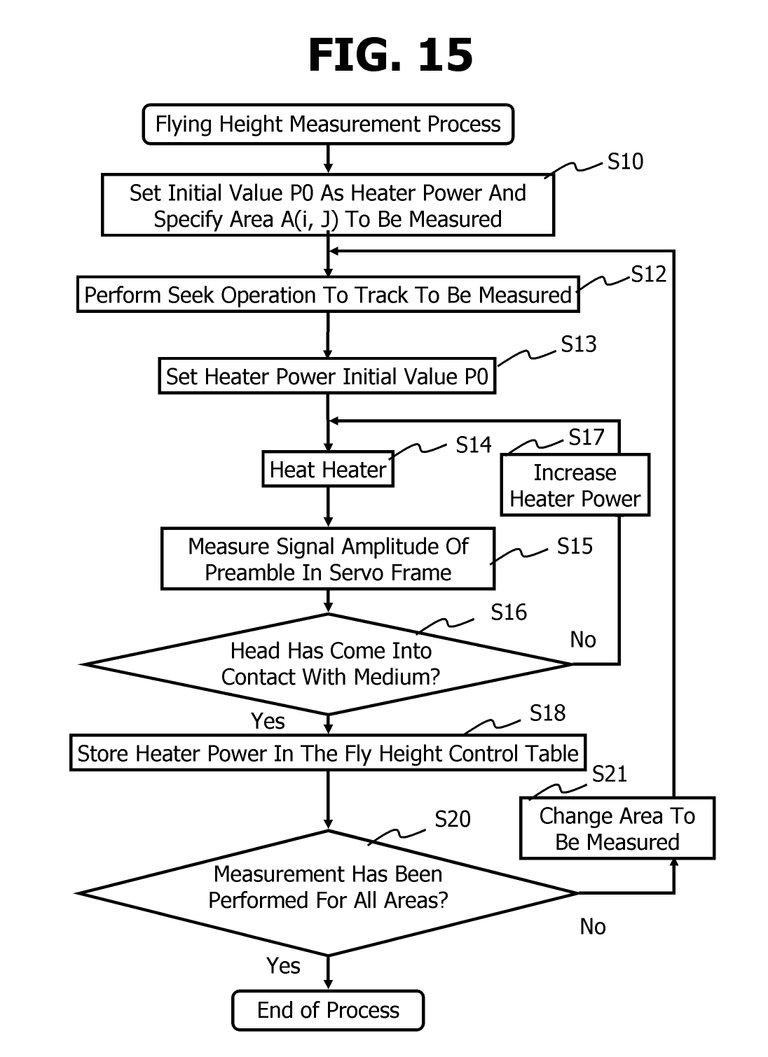

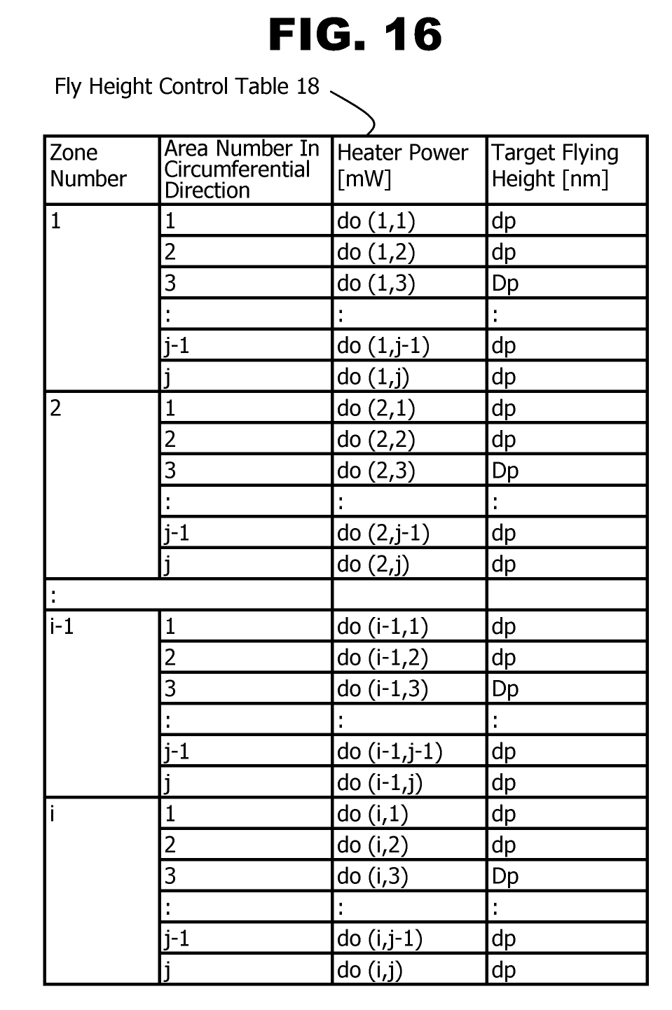

FIG. 15 is a flowchart illustrating the process of the measurement of fly height for describing the present embodiment. FIG. 16 illustrates the fly height control table 18 created by the process illustrated in FIG. 15.

The process illustrated in FIG. 15 is performed by execution of a measurement program stored in the RAM 15 or the ROM 16 by the MCU 13 in FIG. 2. In the process illustrated in FIG. 15, heater power to be set to control fly height is measured for each head in a hard disk drive (HDD), for each zone formatted in the Zone Bit Recording (ZBR) format, and for each of the areas divided in the circumferential direction.

The MCU 13 specifies and selects a head number to be measured in ascending order. In step S10, the MCU 13 sets an initial value P0 as heater power. Then, the MCU 13 specifies an area A(i, j) to be measured in ascending order.

In step S12, the MCU 13 causes the VCM 5 to perform a seek operation so as to place the magnetic head 2 above a track to be measured of the specified area A(i, j) to be measured. In step S13, The MCU 13 sets the heater power initial value P0 in the heater control circuit in the preamplifier 6 upon placing the magnetic head 2 above the track.

In step S14, the MCU 13 sends an on signal to the heater control circuit to apply the set heater power to the heater 24 via the heater drive circuit 61. That is, the MCU 13 sets the specified heater power in the heater control circuit, heats the heater 24. In step S15, the MCU 13 measures the signal amplitude of a preamble in a servo frame read by the read element 20 in the magnetic head 2.

In step S16, the MCU 13 determines whether signal amplitude has decreased to determine whether the magnetic head 2 has come into contact with the medium 3, as illustrated in FIGS. 11 and 12. When the MCU 13 determines that the magnetic head 2 has not come into contact with the medium 3, the MCU 13 increases the heater power by a predetermined value in step S17, and the process returns to step S14.

On the other hand, when the MCU 13 determines that the magnetic head 2 has come into contact with the medium 3, the heater power applied at this time is heater power corresponding to the current fly height. Thus, in step S18, the MCU 13 calculates heater power corresponding to target fly height according to equation (1) and stores the heater power in the fly height control table 18 illustrated in FIG. 16. The fly height control table 18 illustrated in FIG. 16 stores target fly height and heater power for achieving the target fly height corresponding to each combination of a zone number assigned in the radial direction and a circumferential area number. In detail, the fly height control table 18 stores target fly height and heater power for achieving the target fly height corresponding to each of the areas A(1, 1) to A(i, j) divided in the radial and circumferential directions, as illustrated in FIGS. 5 and 9. In this case, i is a zone number assigned in the radial direction, and j is an area number assigned in the circumferential direction.

In step S20, the MCU 13 determines whether the measurement has been performed for all the areas. When the MCU 13 determines that the measurement has not been performed for all the areas, the MCU 13 changes the area to be measured to perform the measurement for the next area in step S21, and the process returns to step S12. On the other hand, when the MCU 13 determines that the measurement has been performed for all the areas, the MCU 13 completes the measurement of the fly height of a head of interest.

When a plurality of heads exist, for each of the heads, the measurement process is performed to create the fly height control table 18 for each of the heads.

The medium 3 is divided into areas in the circumferential direction, and heater power for achieving optimum fly height is measured for each of the areas in the circumferential direction to create the fly height control table 18 in this manner. Thus, the clearance can be corrected so as to be constant by changing heater power to be applied to the heater 24 for each of the areas, as illustrated in FIG. 8A and FIG. 8B. That is, for the entire surface of the medium 3, while the smallest fly height with which reliability about contact between the magnetic head 2 and the medium 3 can be achieved is ensured, control can be performed so as to achieve small fly height advantageous for read and write characteristics.

Read and Write Operations in which Fly Height Control is Performed

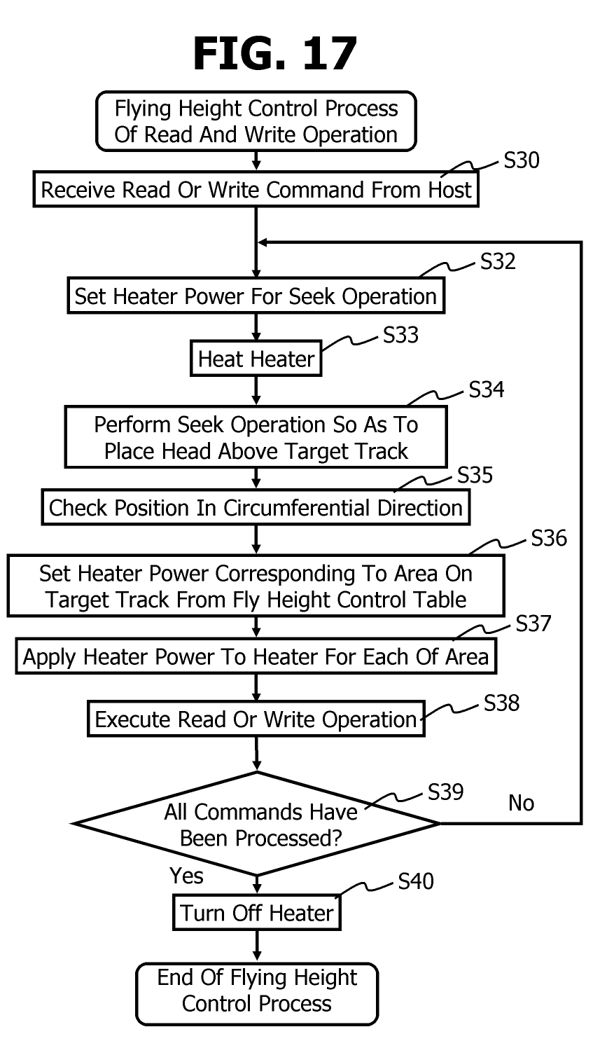

FIG. 17 is a flowchart illustrating the process of read and write operations according to an embodiment of the present invention.

In step S30, the HDC 14 receives a read or write command from a host.

In step S32, the MCU 13 sets heater power for a seek operation in the heater control circuit. The heater power for a seek operation may be, for example, the average of heater powers in the fly height control table 18 or predetermined heater power.

In step S33 through S35, the MCU 13 analyzes the read or write command to determine a requested head and a target cylinder in which requested data exists. Then, in step S33, the MCU 13 sends an on signal to the heater control circuit to apply the set heater power to the heater 24 via the heater drive circuit 61. Moreover, in step S34, the MCU 13 causes the VCM 5 to perform a seek operation so as to place the magnetic head 2 above a target track, in step S35, checks the address from signals read by the read element 20 in the magnetic head 2, and checks the position in the circumferential direction.

In step S36, the MCU 13 reads heater power corresponding to an area on the target track from the fly height control table 18 read from a system area in the magnetic disk 3 and loaded into the RAM 15, sets the heater power in the heater control circuit, and then sends an on signal to the heater control circuit to apply the set heater power to the heater 24 via the heater drive circuit 61.

In step S38, the MCU 13 executes the command, cooperating with the HDC 14. Specifically, the MCU 13 reads or writes data from or to a target sector while controlling the requested head so as to achieve the target fly height by heater power.

After the read or write operation is completed, in step S40, the MCU 13 determines whether all commands received from the host have been processed. When the MCU 13 determines that all the commands received from the host have not been processed, the process returns to step S32 where the MCU 13 performs a read or write operation specified by the next command.

When the MCU 13 determines that all the commands received from the host have been processed, in step S42, the MCU 13 turns off the heater 24 and completes command processing.

The magnetic head 2 flies at optimum fly height above a sector subjected to a read or write operation in this manner. Thus, while the smallest fly height with which reliability about contact between the magnetic head 2 and the medium 3 can be achieved is ensured, read and write characteristics can be improved.

The head fly height control device and the magnetic storage device may improve read and write characteristics. The fly height control device and the magnetic storage device improve read and write characteristics by optimally controlling the fly height of a head in the circumferential direction of a magnetic recording medium. The head fly height control device and the magnetic storage device improve read and write characteristics while the minimum fly height at which a collision of a head with a magnetic recording medium is avoided is ensured.

### Another Method for Measuring Fly Height

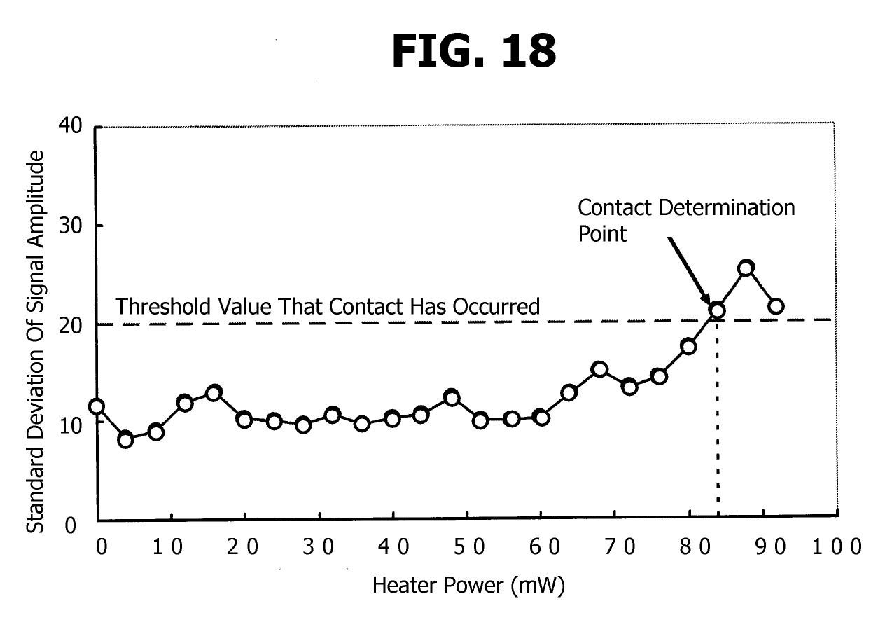

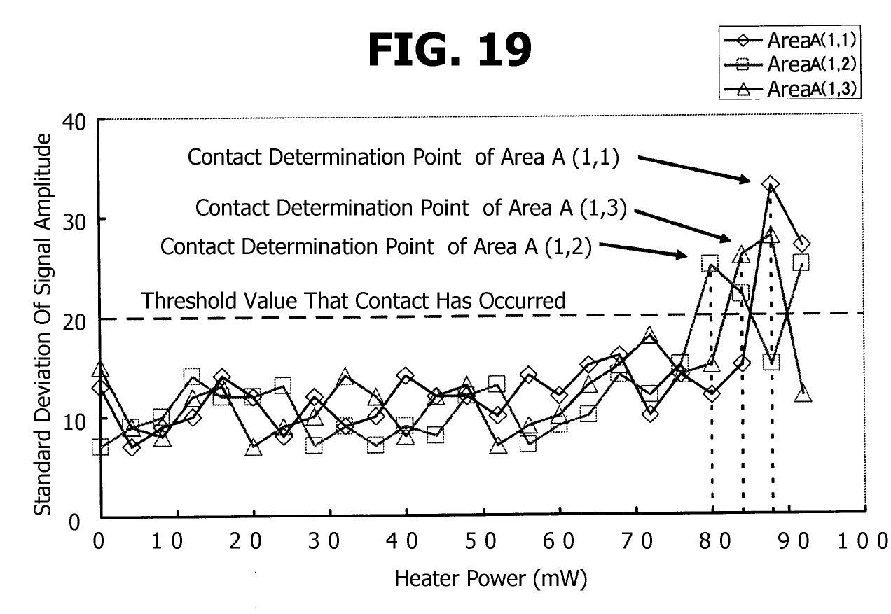

FIGS. 18 and 19 illustrate a method for measuring fly height according to a second embodiment of the present invention.

In the embodiment in FIGS. 11 and 12, an example in which it is determined on the basis of a change in the level of signal amplitude whether contact has occurred has been described. On the other hand, in this embodiment, the variance of signal amplitude or the variation of the standard deviation of signal amplitude is obtained, and it is determined upon detecting that the variance or the variation exceeds a contact determination threshold value that contact has occurred.

At a point where a head comes into contact with a medium, the head jumps and vibrates due to the contact, so that the variation of signal amplitude becomes large, as illustrated in FIG. 18. Thus, the variance or standard deviation of signal amplitude becomes large. FIG. 18 illustrates the relationship between the variation of the standard deviation of signal amplitude (the vertical axis) and heater power (the horizontal axis).

FIG. 19 illustrates points where contact is determined by heater power and the standard deviation of signal amplitude in the same three areas A(1, 1), A(1, 2), and A(1, 3) as in FIG. 12. In the measurement of fly height, when the standard deviation of signal amplitude exceeds the contact determination threshold value, it is determined that a head has come into contact with a medium. The method for controlling fly height by calculating heater power corresponding to target fly height from the result of measurement of fly height is similar to that in the case where, when signal amplitude decreases, it is determined that contact has occurred.

Moreover, the RDC 12 includes a thermal asperity (TA) detection circuit that detects thermal asperity. Thus, it may be determined whether a TA detection signal of the TA detection circuit has occurred to determine whether contact has occurred. Moreover, the MCU 13 may determine by checking read operations whether a read error has been detected to determine whether contact has occurred.

### Another Embodiment

The fly height control table 18 may be stored in a predetermined area in the magnetic disk medium 3 or a nonvolatile memory, for example, the ROM 16. For a write request, since a calorific value due to the application of write current is added, it is preferable that corrected heater power obtained by subtracting heater power corresponding to the additional calorific value due to the application of write current from heater power set for a read request be used. Thus, a calculation process or a control table similar to the fly height control table 18 may be provided for implementing this arrangement.

The measurement is preferably performed in a test process before shipment of products. Alternatively, the measurement may be performed in automatic calibration after shipment. Moreover, the measurement may be performed on any area in a magnetic disk. However, when the measurement is performed, a head is brought into contact with the magnetic disk. Thus, the measurement is preferably performed on a system area other than a user area.

While a magnetic disk device that includes two magnetic disks has been described in the aforementioned embodiments, the present invention can be also applied to a magnetic disk device that includes a magnetic disk or three or more magnetic disks. Moreover, the present invention can be applied to not only the magnetic head illustrated in FIG. 4 but also another separation type magnetic head.

Moreover, a heater drive circuit may not be provided in a head ID but may be provided on the side of a control circuit. A magnetic head may include a read element and a heating element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A device for storing data comprising:
a medium for storing data, the medium having a plurality of areas in a circumferential direction;
a head including a read element for reading data from the medium along the circumferential direction, a write element for writing data into the medium along the circumferential direction, and a heater for controlling a distance between the head and the medium;
a memory for storing information of a parameter of the heater for controlling the distance between the head and the medium; and
a controller for controlling the heater to control the distance between the head and the medium separately among the areas when reading data from or writing data into any one of the areas of the medium.

2. The device according to claim 1, wherein after the controller heats the heater, the controller reads or writes data stored the area specified in a read or write operation.

3. The device according to claim 1, wherein the memory stores a power parameter for achieving predetermined fly height at each of a plurality of areas into which the medium is divided in radial and circumferential directions of the medium, and the controller reads, from the memory, one of the power parameters of one of the plurality of areas corresponding to a read or write position on the medium specified in a read or write operation and heats the heater.

4. The device according to claim 1, wherein the memory stores a power parameter measured when it is determined, on the basis of output from the read element, that contact has occurred while the power parameter is increased at each of a plurality of areas into which the magnetic recording medium is divided in radial and circumferential directions of the medium.

5. The device according to claim 3, wherein at each of the plurality of areas, while increasing the power parameter, the controller determines, on the basis of output from the read element, whether contact has occurred and measures the power parameter observed when determining that contact has occurred to create the memory.

6. The device according to claim 5, wherein, while increasing the power parameter, the controller measures signal amplitude output from the read element to determine, on the basis of variation of the signal amplitude, whether contact has occurred and measures the power parameter observed when determining that contact has occurred to create the memory.

7. The device according to claim 5, wherein, while increasing the power parameter, the controller measures signal amplitude output from the read element and calculates variance or standard deviation of the signal amplitude to determine, upon detecting that the variance or standard deviation exceeds a predetermined threshold value, that contact has occurred and measures the power parameter observed when determining that contact has occurred to create the memory.

8. The device according to claim 3, wherein, while increasing the power parameter, the controller measures signal amplitude of a preamble in a servo frame of the medium output from the read element to determine, on the basis of the measured signal amplitude, whether contact has occurred and measures the power parameter observed when determining that contact has occurred to create the memory.

9. The device according to claim 1, wherein, in the read or write operation, while heating the heating element with a predetermined power parameter, the controller performs a seek operation so as to place the head above the one of the plurality of areas corresponding to the position on the medium specified in the read or write operation, and the controller, after performing the seek operation, heats the heater according to the one of the power parameters corresponding to the position on the medium specified in the read or write operation.

10. A fly height control device for controlling fly height of a head including a read element, a write element, and a heater and is caused to fly by rotation of a medium, the fly height control device comprising:
a fly height control table for storing a power parameter for achieving predetermined fly height at each of a plurality of areas into which the medium is divided at least in a circumferential direction of the medium; and
a controller for reading one of the power parameters of one of the plurality of areas corresponding to a read or write position on the medium specified in the read or write operation, and for heating the heater according to the read power parameter to control fly height of the head from the medium so as to be the predetermined fly height in a read or write operation from the fly height control table.

11. The fly height control device according to claim 10, wherein, after the controller heats the heater according to the read power parameter, the controller reads or writes data in the read or write position on the medium specified in the read or write operation.

12. The fly height control device according to claim 11, wherein the fly height control table stores the power parameter measured when it is determined, on the basis of output from the read element, that contact has occurred while the power parameter is increased at each of a plurality of areas into which the medium is divided in radial and circumferential directions of the medium.

13. The fly height control device according to claim 12, wherein, at each of the plurality of areas, while increasing the power parameter, the control circuit determines, on the basis of output from the read element, whether contact has occurred and measures the power parameter observed when determining that contact has occurred to create the fly height control table.

14. The fly height control device according to claim 13, wherein, while increasing the power parameter, the control circuit measures signal amplitude output from the read element to determine, on the basis of variation of the signal amplitude, whether contact has occurred and measures the power parameter observed when determining that contact has occurred to create the fly height control table.

15. The fly height control device according to claim 13, wherein, while increasing the power parameter, the controller measures signal amplitude output from the read element and calculates variance or standard deviation of the signal amplitude to determine, upon detecting that the variance or standard deviation exceeds a predetermined threshold value, that contact has occurred and measures the power parameter observed when determining that contact has occurred to create the fly height control table.

16. The fly height control device according to claim 11, wherein, while increasing the power parameter, the controller measures signal amplitude of a preamble in a servo frame of the medium output from the read element to determine, on the basis of the measured signal amplitude, whether contact has occurred and measures the power parameter observed when determining that contact has occurred to create the fly height control table.

17. The fly height control device according to claim 10, wherein, in the read or write operation, while heating the heating element with a predetermined power parameter, the controller performs a seek operation so as to place the head above the one of the plurality of areas corresponding to the read or write position on the medium specified in the read or write operation, and the controller, after performing the seek operation, heats the heater according to the one of the power parameters corresponding to the read or write position on the medium specified in the read or write operation.
